(19) United States
(12) Patent Application Publication
(10) Pub. No.: US 2007/0057395 A1
(43) Pub. Date: Mar. 15, 2007

(54) Process for producing thermoplastic resin molding

(76) Inventors: Kazuyuki Yamane, Iwaki-City (JP); Toshiya Mizuno, Niihari-Gun (JP); Yukichika Kawakami, Iwaki-City (JP); Shiro Suzuki, Iwaki-City (JP); Yoichiro Yamanobe, Iwaki-City (JP); Toshio Hosokawa, Iwaki-City (JP); Takumi Katsurao, Iwaki-City (JP)

Correspondence Address: REED SMITH LLP, 3110 FAIRVIEW PARK DRIVE, FALLS CHURCH, VA, 22042, US

(21) Appl. No.: 10/557,905

(22) PCT Filed: May 26, 2004
(86) PCT No.: PCT/JP04/07565

§ 371 Date: Nov. 22, 2005

(30) Foreign Application Priority Data
May 27, 2003 (JP) 2003-149692

(51) Int. Cl. B29C 67/20; B29B 7/00; C08F 6/00

(52) U.S. Cl. 264/41; 264/349; 528/480

(57) ABSTRACT

A polyglycolic acid resin is used as a forming aid to efficiently produce various shapes, such as porous film, ultrafine fiber, ultrafine film and porous hollow fiber, of shaped products of substantially water-insoluble thermoplastic resins. More specifically, a shaped composite of the polyglycolic acid resin and the substantially water-insoluble thermoplastic resin is caused to contact an aqueous medium, thereby selectively removing the polyglycolic acid resin through solvolysis and extraction to leave a shaped product of the remaining thermoplastic resin. A glycolic acid aqueous produced by the solvolysis and extraction can be recycled into the polyglycolic acid resin as a forming aid via the formation of a concentrated glycolic acid oligomer and glycolide.

### TECHNICAL FIELD

The present invention relates to a process for producing a thermoplastic resin molding or shaped product and a thermoplastic resin shaped product thus produced based on a discovery of a peculiar suitability of a polyglycolic acid resin as a shaping aid to be removed by extraction from a final shaped product.

### BACKGROUND ART

The usefulness of shaped products in various shapes of various thermoplastic resins is widely known. Known examples of the various shapes of thermoplastic resin shaped products may include films, sheets, yarns or fiber, stretched products of these, hollow fiber, hollow vessels, and porous products of these.

There have been known a class of techniques for forming these shaped products, particularly porous products thereof, wherein a thermoplastic resin and a plasticizer therefor are kneaded and shaped, and the plasticizer is extracted from the shaped product to form a porous shaped product of thermoplastic resin. For example, processes for producing porous membranes of thermoplastic resin as represented by hollow fiber used as a membrane for treatment of water by kneading the thermoplastic resin with a plasticizer under heating and removing the plasticizer by extraction are described in, e.g., JP-A 3-215535, JP-A 7-13323, JP-A 2000-309672, and a specification of Japanese Patent Application 2003-110212 according to the present applicant.

However, the above-mentioned use of a plasticizer as a forming aid is accompanied with problems such that (a) the use of an organic solvent as an extraction liquid is necessary so that the process requires troublesome treatment, separation and recovery of the liquid mixture of the organic solvent and the plasticizer, and (b) the plasticizer exhibits an effect of plasticizing the thermoplastic resin as a matter of course, so that even if the shaped body obtained after hot kneading of the thermoplastic resin and the plasticizer is stretched, it becomes difficult to exhibit expected stretching effects (i.e., effects of elongating the polymer chains of the thermoplastic resin through reduction of “sagging” or “entanglement” of the polymer chains to improve the properties, such as tensile strength, by applying an elongating stress to the shaped body).

In view of the above, principally for solving the above-mentioned problem (b) accompanying the use of a plasticizer as a forming aid, it has been known to use a thermoplastic resin different from the thermoplastic resin forming the final shaped product as a forming aid and selectively removing the thermoplastic resin as the forming aid by extraction from the stretched shaped product. For example, there has been known a process of spinning a composite fiber of a water-soluble polymer and a polyester resin and removing the water-soluble polymer by extraction with hot water, etc., to produce a porous polyester fiber (JP-A 2002-220741). In many of such cases, such two-types of thermoplastic resins are disposed in a specific regular positional relationship to form a stretched shaped body and then subjected to the extraction-removal step. More specifically, there are known, e.g., processes of co-extruding two species of thermoplastic resins through a composite nozzle comprising a combination of nozzles having different diameters to form an extruded filament or mutual polymer arrangement body having a cross-sectional shape wherein one resin is disposed as “sea” and the other resin is disposed as “island(s)”, and removing the one thermoplastic resin as a forming aid constituting the “sea” (matrix) by extraction to form ultrafine fibers (JP-B 44-18369, JP-B 46-3816, JP-B 48-22126, etc.), or removing one thermoplastic resin constituting the “island(s)”) by extraction to form a hollow fiber (JP-A 7-316977, JP-A 2002-220741, etc.); and a process of forming a sheet comprising two species of thermoplastic resins which are laminated alternately and obliquely and removing one thermoplastic resin as a forming aid by extraction to form very thin films (JP-A 9-87398).

However, the above-mentioned processes of using an additional resin as a forming aid are also accompanied with problems such that the extraction solvents are mostly organic solvents and even in the case of water, the treatment of the resultant polymer solution after the extraction is troublesome, and the thermoplastic resins as the forming aids are basically polymers so that the removal by extraction thereof is more difficult than that of a plasticizer.

### DISCLOSURE OF INVENTION

Accordingly, a principal object of the present invention is to provide a process for producing a thermoplastic resin shaped product capable of providing essential improvements to many of the above-mentioned problems involved in the conventional processes for producing thermoplastic resin shaped products using a plasticizer or a thermoplastic resin as a forming aid.

Another object of the present invention is to provide various shapes of thermoplastic resin shaped products formed through the above-mentioned process.

The present inventors have noted that a polyglycolic acid resin known as a biodegradable resin exhibits solvolizability with solvents similar to water, inclusive of water and lower alcohols, etc., which are inclusively referred to herein as “aqueous medium”, while it exhibits excellent mechanical properties, such as rigidity, which cannot be expected at all to a plasticizer, under its polymer state. As a result, the present inventors have had a concept that the polyglycolic acid resin may be suitable as a forming aid in production of a water-insoluble thermoplastic resin shaped product and also have confirmed the usefulness and an advantage in recovery thereof to arrive at the present invention.

Thus, according to the present invention, there is provided a process for producing a thermoplastic resin shaped product, comprising: causing a shaped composite of a polyglycolic acid resin and a substantially water-insoluble thermoplastic resin to contact an aqueous medium, and selectively removing the polyglycolic acid resin by solvolysis and extraction thereof from the shaped composite, thereby recovering a shaped product of the remaining thermoplastic resin.

The present invention further provides various shapes of useful thermoplastic resin shaped products thus produced.

### BRIEF DESCRIPTION OF THE DRAWINGS

FIG. 1 is a SEM photograph (magnification: 6000) of a section in a stretched direction of an example of porous film (FA4 described hereinafter) obtained by the process of the present invention.

FIG. 2 is a SEM photograph (magnification: 6000) of section in a stretched direction of an example of composite film (FA5) prior to extraction used in the process of the present invention.

FIG. 3 is a SEM photograph (magnification: 6000) of a section in a stretched direction of another example of porous film (FA5; after 5 hours of extraction at 85° C.) obtained by the process of the present invention.

FIG. 4 is a SEM photograph (magnification: 6000) of a section in a stretched direction of another example of porous film (FA5; after 1 hour of extraction at 85° C.) obtained by the process of the present invention.

FIG. 5 is a SEM photograph (magnification: 6000) of another example of porous film (FS1) obtained according to the process of the present invention.

FIG. 6 is a SEM photograph (magnification: 6000) of another example of porous film (FS2) obtained according to the process of the present invention.

FIG. 7 is a SEM photograph (magnification: 6000) of another example of porous film (FS3) obtained according to the process of the present invention.

FIG. 8 is a SEM photograph (magnification: 6000) of another example of porous film (FS4) obtained according to the process of the present invention.

FIG. 9 is a SEM photograph (magnification: 6000) of another example of porous film (FS5) obtained according to the process of the present invention.

FIG. 10 is a SEM photograph (magnification: 6000) of another example of porous film (FS6) obtained according to the process of the present invention.

FIG. 11 is a SEM photograph (magnification: 5000; PET/PGA=75/25) of a section in a longitudinal direction of an example of fine fiber bundle obtained by the process of the present invention.

FIG. 12 is a SEM photograph (magnification: 5000; PET/PGA=50/50) of a section in a longitudinal direction of another example of fine fiber bundle obtained by the process of the present invention.

FIG. 13 is a SEM photograph (magnification: 5000; PET/PGA=25/75) of a section in a longitudinal direction of another example of fine fiber bundle obtained by the process of the present invention.

FIG. 14 is a SEM photograph (magnification: 5000; PET/PGA=75/25) of a section in a diametrical direction of an example of fine fiber bundle obtained by the process of the present invention.

FIG. 15 is a SEM photograph (magnification: 5000; PET/PGA=50/50) of a section in a diametrical direction of an example of fine fiber bundle obtained by the process of the present invention.

FIG. 16 is a SEM photograph (magnification: 5000; PET/PGA=25/75) of a section in a diametrical direction of an example of fine fiber bundle obtained by the process of the present invention.

### BEST MODE FOR PRACTICING THE INVENTION

Hereinafter, the process for producing a thermoplastic resin shaped product according to the present invention will be described in the order of steps involved therein.

(Polyglycolic Acid Resin)

The polyglycolic acid resin (hereinafter sometimes referred to as the “PGA resin”) used as a forming aid in the process for producing a thermoplastic resin shaped product of the present invention may include a homopolymer of glycolic acid (including a ring-opening polymerization product of glycolide (GL) that is a bimolecular cyclic ester of glycolic acid) consisting only of glycolic acid-recurring unit represented by formula (I) below:
—(—O—CH₂—C(O)—)— (I),
and also a polyglycolic acid copolymer comprising at least 55 wt. % of the above-mentioned glycolic acid-recurring unit.

Examples of comonomer providing the polyglycolic acid copolymer together with a glycolic acid monomer, such as the above-mentioned glycolide, may include: cyclic monomers, such as ethylene oxalate (i.e., 1,4-dioxane-2,3-dione), lactides, lactones (e.g., β-propiolactone, β-butyrolactone, β-pivalolactone, γ-butyrolactone, δ-valerolactone, β-methyl-δ-valerolactone, and ε-caprolactone), carbonates (e.g., trimethylene carbonate), ethers (e.g., 1,3-dioxane), ethers (e.g., dioxanone), amides (ε-caprolactam); hydroxycarboxylic acids, such as lactic acid, 3-hydroxypropanoic acid, 3-hydroxybutanoic acid, 4-hydroxybutanoic acid and 6-hydroxycaproic acid, and alkyl esters thereof; substantially equi-molar mixtures of aliphatic diols, such as ethylene glycol and 1,4-butanediol, with aliphatic dicarboxylic acids, such as succinic acid and adipic acid, or alkyl esters thereof; and combinations of two or more species of the above.

In the present invention, the PGA resin is subjected to solvolysis with an aqueous medium, such as water (or steam) or alcohol, and is finally removed by extraction. In order to facilitate the removal by extraction, it is preferred that the content of the above-mentioned glycolic acid recurring unit in the PGA resin is at least 70 wt. %, further preferably at least 90 wt. %, most preferably at least 95 wt. %.

The molecular weight of the PGA resin may depend on whether a shaped composite described hereinafter is formed by hot kneading and shaping of the PGA resin and a water-insoluble thermoplastic resin (hereinafter sometimes referred to simply as a “thermoplastic resin”) or a regularly arranged shaped article of these resins, and also on the molecular weight of the thermoplastic resin. This is because, even in the case of forming a porous shaped product from a hot-kneaded and shaped composite as described hereinafter, for example, the dispersed shapes of PGA resin, i.e., the shape and distribution of resultant pores (or voids), etc., can vary depending on a viscosity ratio of the thermoplastic resin and the PGA resin during hot kneading. Generally, in consideration of hot-kneadability, stretchability, etc., in the case of using an aromatic polyester resin as a most preferred example of the thermoplastic resin for producing a sheet or fiber described hereinafter, and also in other cases, the PGA resin may preferably have a weight-average molecular weight (based on polymethyl methacrylate) in a range of ca. 50,000-600,000, particularly ca. 100,000-300,000, according to GPC measurement using hexafluoroisopropanol solvent.

In order to maintain a thermal stability of the PGA resin at the time of forming a shaped composite through hot or melt kneading or by melt forming, it is possible to co-use a thermal stabilizer. In this case, it is preferred to melt-mix the thermal stabilizer with the PGA resin in advance. The thermal stabilizer may be selected from compounds functioning as anti-oxidants for polymers, and it is preferred to use at least one species of compounds selected from the group consisting of heavy metal-deactivating agents, metal carbonate salts, and phosphoric acid esters including a pentaerythrithol skeleton (or a cyclic neopentane-tetra-il structure) and represented by formula (II) below, and phosphor compounds having at least one hydroxyl group and at least one long-chain alkyl ester group and represented by formula (III) below. Among these, phosphoric acid esters including a pentaerythrithol skeleton (or a cyclic neopentane-tetra-il structure) and represented by formula (II) below, and phosphor compounds having at least one hydroxyl group and at least one long-chain alkyl ester group and represented by formula (III) below, are preferred, because they effectively provide a thermal stability-improving effect at a small addition amount.

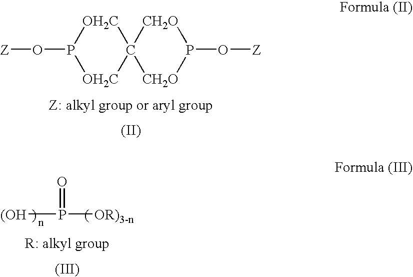

The thermal stabilizer may be incorporated in an amount of ordinarily 0.001-5 wt. parts, preferably 0.003-3 wt. parts, more preferably 0.005-1 wt. part, per 100 wt. parts of the PGA resin. The ordinary amount corresponds to ca. 0.0001-2.5 wt. parts per 100 wt. parts of the PGA composition. If the thermal stabilizer is added in an excessively large amount, it is uneconomical as the addition effect thereof is saturated.

(Thermoplastic Resin)

The thermoplastic resin used for forming a shaped composite together with the PGA resin must be water-insoluble in such a degree that it does not show a substantial solubility with an aqueous medium, optionally elevated in temperature, used for solvolysis and extraction of the PGA resin.

In view of the formability of a shaped composite together with the PGA resin inclusive of the case of forming through hot mixing it is preferred to use a resin having a melt-formability in a temperature range of from ca. −30° C. to ca. +100° C. with respect to the melting point (180-230° C.) of the PGA resin. As far as this condition is satisfied, the thermoplastic resin can be either a hydrophobic resin or a hydrophilic resin within an extent of retaining the water-insolubility.

Examples of the hydrophilic resin may include: aromatic polyester resins, aromatic polyamides of a diamine and a dicarboxylic acid at least one of which is aromatic, aromatic polycarbonates, ethylene-vinyl alcohol copolymer and ionomer resin, acrylic resins such as polymethyl methacrylate, and acrylonitrile resins. Examples of the hydrophobic resin may include: polyvinylidene fluoride resins having excellent chemical resistance and weatherability, polyarylene sulfide resins (PAS), and polyolefins including ethylene-vinyl acetate copolymers (having a vinyl acetate content of at most ca. 15 wt. %). In the case of using a hydrophobic resin, it is also possible to use a hydrophilic resin (or a precursor of hydrophilic resin due to hydrolysis) in order to adjust the hot mixability of the hydrophobic resin with the PGA resin.

In consideration of hot mixability, etc., the thermoplastic resin most preferably used in the present invention is an aromatic polyester resin. This embodiment will be described in detail later.

(Shaped Composite)

The above-mentioned shaped composite of the PGA resin and the thermoplastic resin includes a hot-mixture shaped article which is a shaped article of an apparently uniform mixture, and a regularly arranged shaped article.

The hot-mixture shaped article may have various entire shapes including sheets (this term is used to also cover those having a thickness of 250 μm or smaller which may more appropriately be called “film(s)”), yarn or fiber, hollow fiber, knitted articles and hollow vessels. The methods of shaping a resin mixture into such shapes of articles are well known in the art and it is believed unnecessary to describe them in detail herein. However, in order to facilitate the solvolysis of the PGA resin with an aqueous medium, it is preferred to restrict the thickness or diameter (excluding that of a hollow fiber which is governed by the thickness) to at most 3 mm, particularly at most 1 mm. It is however also possible to form a thicker shaped composite to preferentially remove the PGA resin from its surface layer, thereby forming a shaped product of thermoplastic resin having a porous layer and a core layer retaining the remaining PGA resin since the PGA resin functions as a resin, different from a plasticizer, even if it remains in the shaped product.

On the other hand, as the processes for forming regularly arranged shaped articles, those described in the above-mentioned section of BACKGROUND ART are enumerated, that is, processes of co-extruding two species of thermoplastic resins through a composite nozzle comprising a combination of nozzles having different diameters to form an extruded filament or mutual polymer arrangement body having a cross-sectional shape wherein one resin is disposed as “sea” and the other resin is disposed as “island(s)”, and removing the one thermoplastic resin as a forming aid constituting the “sea” (matrix) by extraction to form ultrafine fibers (JP-B 44-18369, JP-B 46-3816, JP-B 48-22126, etc.), or removing one thermoplastic resin constituting the “island(s)”) by extraction to form a hollow fiber (JP-A 7-316977, JP-A 2002-220741, etc.); and a process of forming a sheet comprising two species of thermoplastic resins which are laminated alternately and obliquely and removing one thermoplastic resin as a forming aid by extraction to form very thin films (JP-A 9-87398). The PGA resin is used in place of the resin removed by extraction in these processes.

It is possible to incorporate a filler, such as mica, talc or carbon black in at least one of the above-mentioned PGA resin and thermoplastic resin according to necessity.

In order to increase the strength, etc., of the thermoplastic resin shaped product as the final product, it is preferred to uniaxially or biaxially stretch the shaped composite formed in the above-described manner. In this case, the advantages of the PGA resin as a forming aid unlike plasticizer can be remarkably exhibited. In order to increase the strength, for example, the stretching ratio may preferably be selected so as to decrease the thickness or cross-sectional area to ca. ⅕ or less.

(Aqueous Medium)

The shaped composite formed in the above-described manner is caused to contact an aqueous medium, thereby selectively solvolyzing and removing the PGA resin by extraction to leave a shaped product of thermoplastic resin.

In the present invention, the “aqueous medium” may include water per se and additionally a solvent which is miscible with water and capable of causing solvolysis of the PGA resin similarly as water. Typical examples of such a water-miscible solvent may include lower alcohols having at most 5 carbon atoms and branched alcohols having 6 carbon atoms, which can be used singly or in mixture with water. In view of the load to the environment, water is most preferred. As a result of the solvolysis and extraction with such an aqueous medium, the PGA resin is converted into glycolic acid or a lower alkyl ester thereof to be contained in the extract liquid.

The aqueous medium may be used at an elevated temperature as desired, which is preferable in order to accelerate the solvolysis. The aqueous medium must be liquid for the extraction but can be in the form of vapor at the time of supply thereof which may be preferable for the purpose of heat supply.

It has been confirmed that the solvolysis of the PGA resin can be accelerated by adding an acid or an alkali to the aqueous medium. Particularly, it is commercially most preferred to add glycolic acid (e.g., a 10 wt. %-aqueous solution of which shows a pH of ca. 1.8) as an acid. More specifically, if an extract liquid after solvolysis and extraction of PGA resin is recycled, the extraction speed is increased when the glycolic acid concentration is up to ca. 70 wt. %.

In case where a shaped composite in the form of fiber (or yarn) is formed, it can be blended with a fiber of another resin (e.g., nylon resin, acrylic resin, etc. with respect to polyester) or formed into fabrics, prior to the above-mentioned solvolysis with an aqueous medium. This is effective, e.g., when the shaped composite fiber, etc., shows a relatively weak strength because of a high PGA resin content.

(Thermoplastic Resin Shaped Product)

As a result of the above-mentioned selective solvolysis and removal by extraction of the PGA resin from the shaped composite, a shaped product of the remaining thermoplastic resin can be obtained. It has been confirmed that the thus-obtained thermoplastic resin shaped product can assume really diverse shapes depending on the forms of the shaped composite and a mutual relationships between the thermoplastic resin and the PGA resin.

First of all, in the case where a hot-mixture shaped article in a form of sheet, fiber or yarn, hollow fiber, knitting, a hollow vessel, etc., is formed as a shaped composite, a porous product thereof is obtained as a thermoplastic resin shaped product after the removal by extraction of the PGA resin. However, the state of appearance of the pores (or voids) therein can vary greatly depending on the relationship between the thermoplastic resin and the PGA resin. Further, as a peculiar phenomenon, it has been confirmed that when spun yarn as a hot-mixture shaped article is subjected to solvolysis and removal by extraction of PGA resin, fine fiber of thermoplastic resin can be obtained. These points will be described in further detail later as phenomena that were confined when an aromatic polyester resin was used as a suitable thermoplastic resin.

Further, in the case where the regularly arranged shaped articles described in the above-described section of (Shaped composite), the corresponding ultrafine fiber, hollow fiber or very thin film can be obtained. Particularly, while the method of forming very thin films per se is disclosed in JP-A 9-87398, the productivity of a shaped composite used for the method according to the present invention of a PGA resin and another thermoplastic resin, i.e., butylene/adipate/terephthalate copolymer (“EnPolG8060”, made by IRe Chemical Co.) or an aliphatic-aromatic polyester copolymer (“Ecoflex”, made by BASF A.G.) was already confirmed in Examples 5-9 of JP-A 2003-189769.

(Post-Treatment)

The thermoplastic resin shaped product after the solvolysis and removal by extraction of the PGA resin in the above-described manner can be subjected, as desired, to a post-treatment, such as uniaxial or biaxial stretching treatment, or heat treatment.

(Post-Treatment of Extract Liquid-Recovery of Glycolic Acid)

The extract liquid after the solvolysis and removal by extraction of PGA resin contains glycolic acid or an ester thereof. If the extract liquid is used repeatedly, the concentration of the glycolic acid or ester thereof is increased by condensation. The concentration as a result of the condensation may preferably be at most 70%. In excess of 70%, the liquid is liable to be solidified at low temperatures, and the transportation or handling thereof is liable to become difficult. In case where the concentration exceeds 70% as a result of the condensation, it is preferred to dilute the liquid with water to keep a concentration of at most 70%. Glycolic acid oligomer can be obtained by subjecting the recovered liquid to condensation and polycondensation, after hydrolysis as required in the case of an ester thereof. The glycolic acid oligomer can be converted into high-purity cyclic ester “glycolide” by using a process as disclosed in, e.g., WO-A 02/14303, and the glycolide can be further subjected to ring-opening polymerization to reproduce polyglycolic acid. Thus, it is a great advantage of the process for producing a thermoplastic resin shaped product according to the present invention using a PGA resin as a forming aid that the process is closely associated with such an extraction system exerting little load to the environment.

More specifically, the process of WO-A 02/14303 allows a process including the step of:

(I) heating a mixture including glycolic acid oligomer (A) recovered in the above-described manner and a polyalkylene glycol ether (B) represented by a formula (1) below:
X¹—O—(—R¹—O—)ₚ—Y (1)
(wherein R¹ denotes a methylene group or a linear or branched alkylene group having 2-8 carbon atoms, X¹ denotes a hydrocarbon group, Y denotes an alkyl or aryl group having 2-20 carbon atoms, and p denotes an integer of at least 1 with the proviso that in case of p is 2 or more, plural R¹ can be the same of different), and having a boiling point of 230-450° C. and a molecular weight of 150-450, to a temperature (e.g., 200-320° C.) causing depolymerization of the glycolic acid oligomer (A) under normal pressure or a reduced pressure of 0.1-90 kPa;

(II) forming a solution state where a molten liquid phase of the glycolic acid oligomer (A) and a liquid phase of the polyalkylene glycol ether (B) form a uniform phase,

(III) continuing the heating in the solution state to distill off glycolide (cyclic ester) formed by the decomposition together with the polyalkylene glycol ether (B); and

(IV) recovering the glycolide from the distillate.

(Aromatic Polyester Resin)

As mentioned above, as the thermoplastic resin forming a shaped composite together with a PGA resin, it is possible to use various thermoplastic resins which are substantially water-insoluble and capable of forming a shaped composite together with a PGA resin, whereas the most preferred resin is an aromatic polyester resin which satisfies the above-mentioned properties, can provide excellent properties to the resultant shaped product, such as fiber, sheet (film), yarn, etc., and can also exhibit excellent hand when formed as a porous product.

Herein, the aromatic polyester resin refers to a polyester, of which at least one of the constituents, i.e., a dicarboxylic acid and a diol, preferably the dicarboxylic acid, is an aromatic one, and a portion of the dicarboxylic acid and/or diol can be replaced with a polycarboxylic acid and/or a polyol having three or more functional groups. It is also possible to use an aliphatic-aromatic copolyester wherein a portion of the aromatic dicarboxylic acid or diol is replaced with an aliphatic dicarboxylic acid or diol. More specifically, it is possible to use an aromatic polyester resin or an aliphatic-aromatic copolyester, such as polyethylene terephthalate (PET), polytrimethylene terephthalate (PTT), polybutylene terephthalate (PBT), or copolymers containing these as principal components.

Among these, the most preferably used aromatic polyester resin is one using terephthalic acid as an aromatic dicarboxylic acid forming a polyester together with at least one species of aliphatic diols, particularly polyethylene terephthalate, whereas it is also possible to preferably use a copolymer provided with controlled hydrophilicity, steric characteristic, etc., by replacing a relatively small portion (e.g., 10 mol % or below) of the terephthalic acid with another dicarboxylic acid, such as isophthalic acid, 5-sodium-sulfo-isophthalic acid, sebacic acid or adipic acid. A thermoplastic resin shaped product principally comprising PET is also suitable from the viewpoint of recycle use.

The aromatic polyester resin can further contain fillers, such as titanium oxide, silica, alumina, and electro-conductive or non-conductive carbon black for the purpose of controlling the hydrophilicity or water permeability, or for other purposes. This also holds true with the other thermoplastic resins.

Hereinbelow, the above-described process for producing a thermoplastic resin shaped product according to the present invention will be supplementally described with reference to an embodiment wherein such an aromatic polyester resin (hereinafter sometimes referred to as “PET resin” representatively) is used as the most preferable thermoplastic resin for forming a shaped composite together with a PGA resin in the present invention through hot mixing.

This embodiment of the process for producing a thermoplastic resin shaped product, i.e., a PET resin shaped product, is principally characterized in that a shaped composite of a PGA resin and a PET resin is caused to contact an aqueous medium, thereby solvolyzing the PGA resin into low-molecular weight substances of glycolic acid or an ester thereof and extracting the low-molecular weight substances from the PET resin to obtain a porous PET resin shaped product, i.e., a PET resin shaped product having pores (or voids). As a result, the states of the voids can be designed in various manners by utilizing the techniques of polymer mixing, i.e., the so-called polymer-alloying techniques, and as the extraction is performed with respect to the low-molecular weight substances, conventional extraction techniques like, e.g., the extraction of a plasticizer with an organic solvent or the technique of dissolving and extracting an inorganic salt with water, can be applied thereto.

As the polymer-alloying techniques, there have been proposed various techniques, inclusive of the controls of compositional ratio, viscosity ratio and shearing force during the kneading, the utilization of a mutual solubilizing agent such as a surfactant, and the utilization of an inter-polymer reaction, such as transesterification. These techniques can also be effectively utilized at the time of forming a shaped composite through hot mixing before the extraction.

The hot-mixture composition of PET resin and PGA resin in the present invention (hereinafter referred to as “PET/PGA composition”) can be easily obtained through melt kneading utilizing known extruders or kneaders.

A thermal stabilizer can be added as described above in the case of kneading at a high melt-temperature or a long heat application time which is liable to lower the thermal stability of the PGA resin.

The PET/PGA composition after the kneading may be provided in the form of pellets or a pulverizate, or obtained directly in the form of a sheet or fiber by directly attaching a sheet-forming die or a spinning nozzle to the melt-kneading apparatus.

The sheet or fiber can be subjected to the extraction as it is but may preferably be stretched in order to enhance the strength. For the purpose of enhancing the strength, the stretching may preferably be performed in such a degree as to provide a thickness of at most ⅕ for sheet of a cross-sectional area of at most ⅕ for fiber. Further, in the case of fiber, the extraction treatment can also be effected after blending with fiber of another resin such as nylon resin or acrylic resin, or after processing into a cloth. This is effective particularly when subjected to a high percentage extraction which is liable to result in a relatively weak PET resin fiber.

A heat treatment before the extraction at an extraction temperature or above can suppress a heat shrinkage of the PET resin after the stretching. The heat-treatment temperature can vary depending on a mixing ratio of the PE resin and the PGA resin due to a difference in thermal property between these resins, but may preferably in a range of 100-150° C. at a composition ratio of PET/PGA of, e.g., 70/30. When heat-treated at such a temperature, the heat-shrinkage stress during the extraction can be remarkably moderated.

The degree of extraction can also be controlled by the extraction time. A PET resin composition having voids can be obtained by controlling the extraction time. More specifically, by controlling the extraction time, the compositional ratio and void ratio in the resultant composition can be controlled. As the extract is a low-molecular weight substance, it is possible to effect a uniform extraction up to the central part of the shaped composite by sufficiently solvolyzing the PGA resin. Accordingly, the extraction can also be applied to a rather thick sheet or a fiber having a large diameter.

An additive, such as mica, talc, pigment or carbon black can be incorporated, and if such an additive is kneaded into the PGA resin in advance, it becomes possible to leave such an additive locally within the voids. By disposing the additive in the voids rather than in the resin, the additive is less liable to be affected by the functional group, etc., of the resin, and the properties of the additive can be promoted. The properties of the additive can be widely controlled by preliminarily incorporating the additive also in the PET resin, by changing the ratio of addition at the time of formation of the composite or by a combination of these.

In the present invention, principal voids (or pores) refer to voids recognizable as space with eyes when a shaped product hardened with liquid nitrogen is cut by a diamond cutter at an environment of −80° C. to expose a section, and the section is observed through a SEM at a magnification of 5000. A void percentage refers to an areal percentage of voids in a 10 μm -wide section when observed through a SEM at a magnification of 4000-8000. The areal percentage can be determined by a known method, such as image analysis or a method of weighing a cut-out from an image picture sheet.

A PGA resin has a larger specific gravity than a PET resin, and it is expected that these resins are partially dissolved with each other through transesterification, so that a dispersion in a molecular level cannot be recognized as a void influencing the void percentage. In the case of the weight method, voids having a level of thickness not recognizable with eyes are ignored. Further, a partial shrinkage of the PET resin can possibly occur. Presumably due to the above factors, a void percentage in terms of an areal percentage shows a smaller value than a weight percentage of extracted PGA resin.

The present inventors conducted extraction experiments for compositions obtained by varying factors, such as species of PET resin, species of PGA resin, compositional ratio and degree of kneading, and observed the resultant voids in the compositions. A part of the experiments are described as Examples appearing hereinafter. In the case of forming sheet-shaped products, for example, the major voids formed in any case exhibited anisotropy between the length (D) in the thickness direction and the length (L) in the lateral direction, giving a ratio L/D of at least 2.0. It has been also found that the size and the percentage of such major voids can be arbitrarily changed by changing the species of the PET resin, the species of the PGA resin, the mixing ratio, the degree of kneading, etc.

In the case of a PET resin having a lower viscosity, the voids tend to be localized on an outer side, and this favors to provide a fiber product, for example, with an opaque or frosting appearance due to random reflection with a smaller percentage of voids. In the case of a PET resin having a higher viscosity, the voids tend to be large in length (D) in the thickness direction, and this favors the designing of an elastic material. Uniform and dense voids formed in the opposite case, i.e., obtained by using a PET resin having a lower viscosity, are useful for the designing of a rigid material.

Various shapes of voids can be provided, such as “slits” or “spongy voids” to sheets and films, and void sectional shapes of “hechima (Chinese melon)” or “lotus root or honey comb”. Further, a multi-layer sheet or a composite sheet can be provided with voids at one or more layers thereof within an extent that the extraction of glycolic acid or an ester thereof is not obstructed thereby. By changing the contents of the PGA resin in the respective layers, it is also possible to provide a multi-layer sheet or composite fiber with different voids percentages. It is also possible to composite the product after the void formation as by lamination or coating, or blending with another fiber.

The extraction temperature can be arbitrarily selected within a temperature range where the PGA resin can be solvolyzed into glycolic acid or an ester thereof, suitable for extraction from the PET resin. A relatively low temperature of, e.g., ca. 80-90° C., may be selected when it is desired to suppress a thermal shrinkage of the PET resin at the time of void formation. A relatively high temperature, such as 120-150° C., can be selected in case where the PET resin is resistant to heat distortion as by crystallization. At a temperature below 60° C., the extraction efficiency is lowered. A temperature of 170° C. or higher can be selected, but the solvolysis of the PET resin has to be considered at such a temperature.

The extraction can be effected at normal pressure or at an elevated pressure. Efficient extraction can be performed at an elevated pressure to increase the osmotic pressure.

The extraction time should be determined while taking various factors into consideration, such as the shape of the shaped composite and the molecular weight and morphology of the PGA resin. It is generally at least 10 min. and at most 24 hours. If the molecular weight of the PGA resin is lowered by contact with some water before the extraction, the extraction time can be shortened. For example, only by subjecting a shaped composite with a polyester resin having absorbed a saturation amount of moisture to 24 hours of heat treatment in an oven at 90° C., the molecular weight of PGA can be lowered to a half or less, thereby reducing the extraction time.

(1) Utilization of a Heat-Shrinkable Shaped Product.

In a case where a thermoplastic resin shaped product having voids and heat-shrinkability is formed by suppressing heat-shrinkage during the shaping process, the shaped product can be used as a heat-insulating material. For example, if such a resin shaped product is caused to intimately contact the outer surface a metal container (e.g., a bottle) of stainless steel or aluminum by utilizing the heat-shrinkability, it becomes possible to provide the metal container with a thermoplastic resin sheathing material giving easy portability even when a hot drink is contained therein. In this instance, the sheathing material can also be combined with another layer, such as a printed PET resin layer, an adhesive layer, a tap adhesive layer or a barrier layer.

(2) Production of Ultrafine Powder

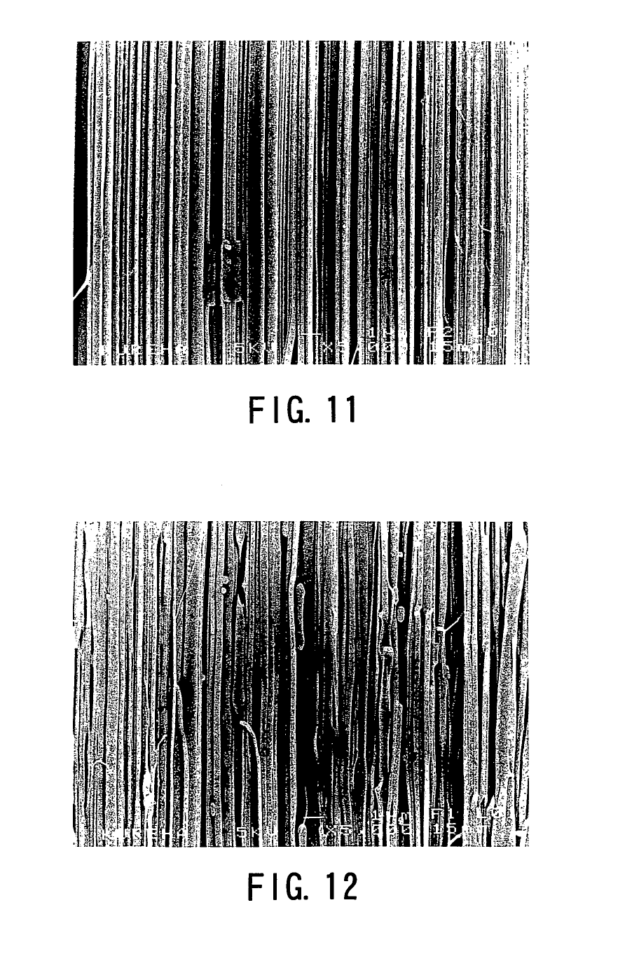

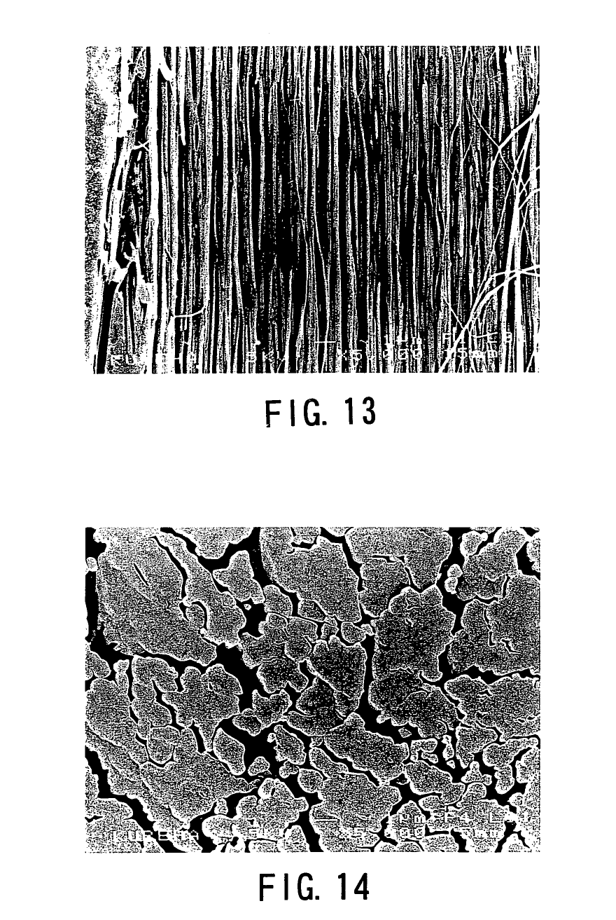

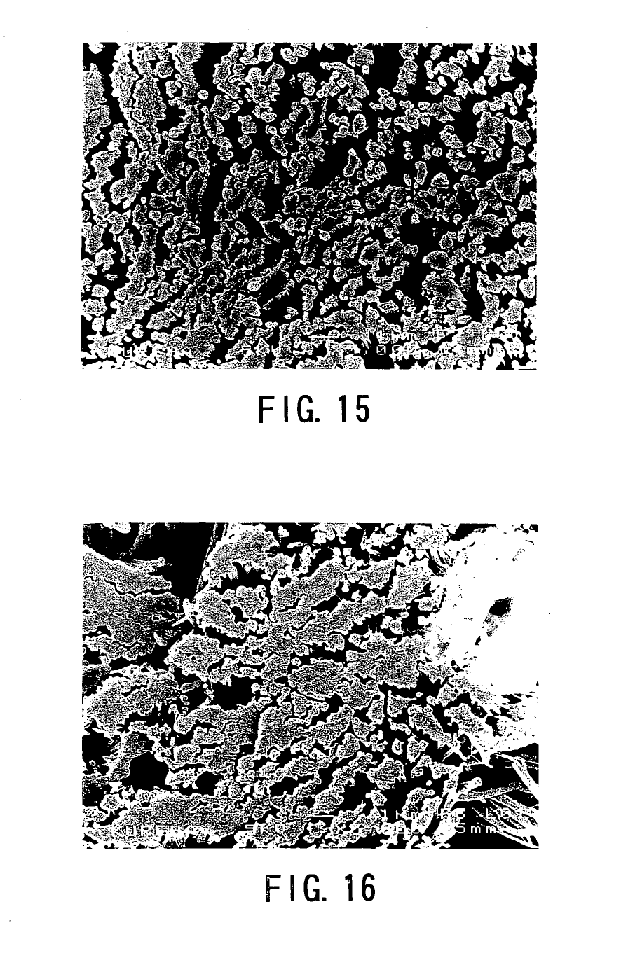

In a case where the above-mentioned hot-kneaded mixture of PGA resin/PET resin is shaped into (stretched) yarn and the yarn is subjected to the solvolysis and removal by extraction of the PGA resin, a very unique phenomenon has been observed that ultrafine fiber of PET resin is obtained instead of porous yarn of PET resin as expected. Such a phenomenon has been observed particularly stretched yarn of hot-kneaded mixture of PGA/PET in a weight ratio range of 25/75-75/25, thus resulting, e.g., 1000-10000 pieces of ultrafine fiber of ca. 0.2-0.5 μm from a stretched yarn of 70 μm in diameter (See Example 3 and SEM photographs (FIGS. 11-16) described later). The phenomenon is understood such that as a result of spinning (and further stretching as desired) of mixture of solvolyzable PGA resin and non-solvolyzable PET resin, a bundle of quite regular fiber or a composite of such a fiber bundle and a matrix is formed, and the PGA resin is selectively removed by solvolysis to leave ultrafine fiber of PET resin. It was really unexpected and is believed industrially useful that the treatment with an aqueous medium of a (stretched) yarn of such a mere hot-kneaded mixture results in ultrafine fiber without the necessity of forming a regularly arranged shaped composite as in JP-B 46-3816 described above.

### EXAMPLES

Hereinbelow, the present invention will be described more specifically based on Examples. Thermoplastic resin shaped products (or shaped composites as precursors thereof) were subjected to the following SEM observation or measurement.

[A.SEM (Scanning Electron Microscope) Observation]

(Sample Preparation)

A sample piece or a plurality of sample pieces, as desired, is set on a microtome equipped with a cryo-kit (“LBK2088 Ultratome V”, made by Bromma Co.) and was cut with a diamond knife under cooling at −120° C. to expose a section thereof. The sample with its exposed section up is attached to an SEM sample stand with an epoxy adhesive and is left standing in a high-temperature vessel at 50° C. to cure the adhesive and simultaneously dry the sample. The sample is then set in an ion sputtering coater (“IB-5 Type” made by Eiko Engineering K.K.) and coated with platinum for 2 min.

The thus-treated sample is then subjected to a SEM observation through an FE-SEM (field emission-scanning electron microscope, “JSM-6301F”, made by Nippon Denshi K. K.)

(Observation Conditions)

Acceleration voltage: 5 kV

Operation distance: 15 mm (a distance from the objective lens to the sample)

Magnification: 5000-6000.

Incidentally, in case where image observation was difficult due to shinning of edges of exposed section, the sample was inclined by 1-6 degrees toward the secondary electron detector side.

(Void Percentage)

A photograph image taken through the SEM is printed on a printing paper having a uniform thickness, and a sample film section is cut out in a width of 10 μm from the printed photograph and is weighed at Z g. Then, from the cut-out film section, an image section photographed in black is cut out and weighed at Y g. The same operation is repeated at three parts in the photograph and a void percentage is determined by substituting the averages into the following formula:
Void percentage (%)=(average of Y/average of Z)×100.
[B. Production of Thermoplastic Resin Shaped Product]
I. Production of Porous Films.

### Example 1

### PET/PGA Composition (1)

(1) Pellet Sample

A 20 mm-dia. reverse-directionally rotating twin-screw extruder (“LT-20”, made by Toyo Seiki K.K.) was used to melt-knead one of PET/PGA compositions (by weight) shown in Table 1 below under the cylinder temperature conditions of 240-250° C. to prepare pellets of the composition. The PET resin was copolymer PET (“PET-DA5”, made by Kanebo Gohsen K. K.; composition: terephthalic acid/dimmer acid/ethylene glycol=95/5/100 (mol/mol/mol); intrinsic viscosity (IV)=0.74). The PGA resin was polyglycolic acid (“PGA-1”, made by Kureha Kagaku K. K.; melt-viscosity (measured at 270° C. and a shear rate of 121/s, similarly as those described below)=680 Pa·s). Table 1 below inclusively shows sample names and composition thereof.

TABLE 1

PET/PGA composition (wt. %)

| Sample name | PET (PET DA5) | PGA (PGA-1) |
|---|---|---|
| A1 | 90 | 10 |
| A2 | 80 | 20 |
| A3 | 70 | 30 |
| A4 | 60 | 40 |
| A5 | 55 | 45 |

(2) Formation and Extraction of Sheets and Stretched Films.

Each of the above-prepared pellet samples A1 to A5 was used to form a stacked structure of metal sheet/aluminum foil/pellet/aluminum foil/metal sheet in the order of from the lower to the upper, and the stacked structure was placed on a pressing table at a surface temperature of 250° C. and, after 3 minutes of preheating, was melt-pressed at a pressure of 70 MPa for 1 minute to obtain a ca. 250 μm-thick sheet.

The thus-obtained sheet was subjected to biaxial stretching at an areal ratio of ca. 10-20 times by tentering. The thus-obtained somewhat rounded stretched film was set on a frame and heat-treated at 180-200° C. for 1 minute under tension to obtain a flat film. The flat film was then subjected to extraction for 8 hours under a hot-water retorting condition of 120° C. The film after the extraction was dried and weight at X g relative to a weight (Y g) before the extraction. Separately, a theoretical weight (P g) of PET was determined based on the PET/PGA ratio, and an extraction ratio was determined as 100×(Y−X)/(Y−P). The results are shown in Table 2 below.

TABLE 2
Stretching ratio and extraction rate

| | Stretched | | Extraction |
|---|---|---|---|
| Sample name | film name | Stretched ratio | rate (%) |
| A1 | FA1 | 18 | 97 |
| A2 | FA2 | 20 | 102 |
| A3 | FA3 | 12 | 93 |
| A4 | FA4 | 18 | 98 |
| A5 | FA5 | 17 | 99 |

(3) Void Percentage

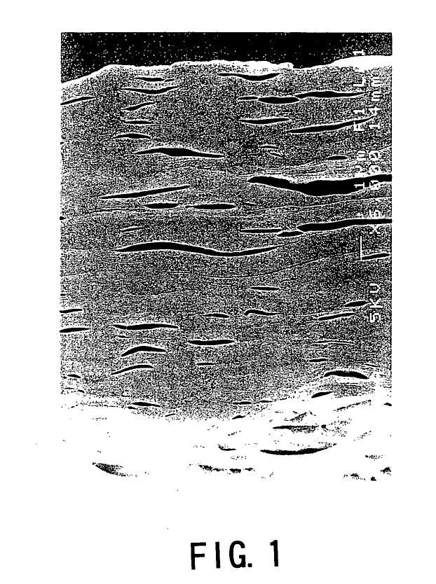

A section of the film after the extraction was observed through a SEM. For example, a photograph of a thickness-wise section along the stretched direction of stretched film FA4 is shown as FIG. 1. Voids were formed in the form of slits opening in the stretched direction of the film. Major voids exhibited a length (L) in a width direction (a direction perpendicular to the stretched direction) and a length (D) in a thickness direction giving a ratio L/D of at least 5. The voids exhibited a distribution of lengths including minute ones to large ones of 10 μm or larger. The voids also exhibited a distribution of thicknesses including minute ones to large ones of 1 μm or larger. The anisotropy and void percentages of major voids are inclusively shown in Table 3. The void percentages were larger for films obtained from sample compositions containing a large PGA content (including A5 as the largest).

TABLE 3
Anisotropy and void percentages of major voids of films after extraction

| | | Thickness of | | |
|---|---|---|---|---|
| Sample | Stretched | extracted | Anistoropy of | Void percentage |
| name | film name | film (μm) | major voids (L/D) | (%) |
| A1 | FA1 | 14 | ≧5 | 6 |
| A2 | FA2 | 13 | ≧5 | 8 |
| A3 | FA3 | 20 | ≧5 | 10 |
| A4 | FA4 | 14 | ≧5 | 12 |
| A5 | FA5 | 15 | ≧5 | 15 |

(4) Additional Sample Observation

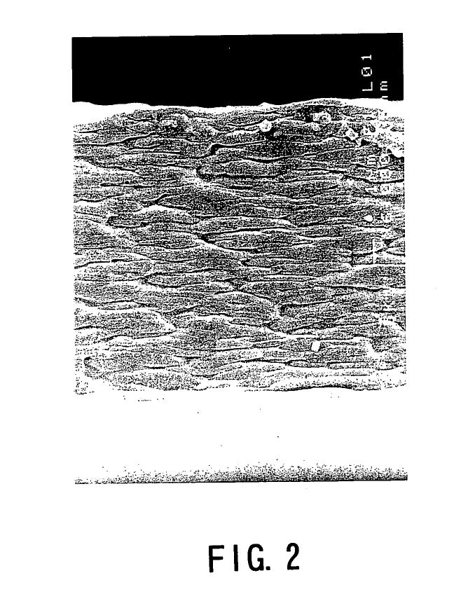

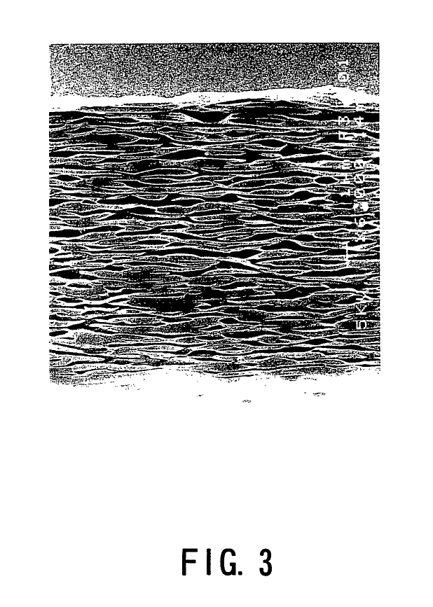

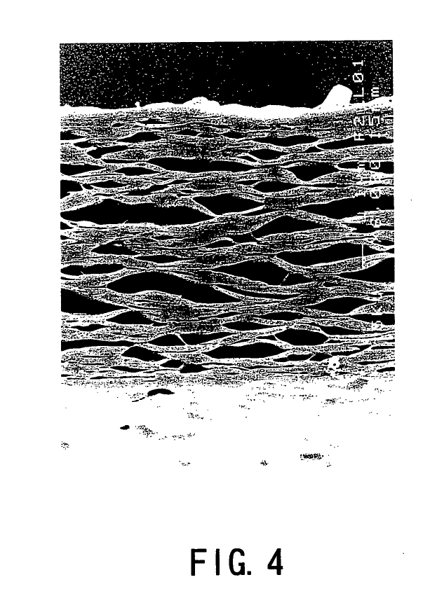

Additional film samples for SEM observation were prepared with respect to stretched film FA5, i.e., one before the extraction, one after 1 hour of extraction with hot water of 85° C. and one after 5 hours of extraction with hot water of 85° C., and after exposing sections, were subjected to photographing through SEM. The results are shown in FIGS. 2-4, respectively. The photographs show that voids were gradually enlarged without substantially changing the sample thicknesses. A void percentage determined from FIG. 4 was 36%.

### Example 2

### PET/PGA Composition (2)

(1) Pellet Sample

A 20 mm-dia. reverse-directionally rotating twin-screw extruder (“LT-20”, made by Toyo Seiki K. K.) was used to melt-knead a PET/PGA composition (by weight) shown in Table 4 below under the cylinder temperature conditions of 240-250° C. to prepare pellets of the composition. The PET resin was (“9921W” (IV=0.8), made by Eastman Kodak Co.) The PGA resin was polyglycolic acid (“PGA-2”, made by Kureha Kagaku K. K.; melt-viscosity=718 Pa·s). Table 4 below summarizes melt-viscosity data, etc.

TABLE 4
Sample name: B1

PET/PGA composition ratio: 50/50 wt. %
PET: 99921W
PGA: PGA-2, melt-viscosity: 718 Pa · s (at 270° C./121 s⁻¹)
PET/PGA composition: melt viscosity = 320 Pa · s(at 270° C./121 s⁻¹).

(2) Sheet Formation

Each of several combinations of PET resins and PGA resins having different viscosities, and the PET/PGA blend composition (B1) obtained in (1) above, was extruded through a 40 mm-dia. single-screw extruder equipped with a 300 mm-wide T-die under cylinder temperature conditions of 230° C.-270° C. and cooled on a cooling roller to obtain sheets S1-S6. The compositions are inclusively shown in Table 5.

TABLE 5

| | | PET (melt-viscosity: | PGA (melt-viscosity: |
|---|---|---|---|
| Sheet | PET/PGA ratio | [Pa · s] at 270° C./ | [Pa · s] at 270° C./ |
| name | wt %/wt % | 121 s⁻¹) | 121 s⁻¹) |
| S1 | 50/50 | 9921W (660) | PGA-2 (718) |
| S2 | 50/50 | Sample B1 (melt-viscosity: 320 Pa · s) | |
| S3 | 50/50 | IFG8L (480) | PGA-2 (718) |
| S4 | 50/50 | 710B4 (2800) | PGA-2 (718) |
| S5 | 25/75 | 710B4 (2800) | PGA-2 (718) |
| S6 | 75/25 | 710B4 (2800) | PGA-2 (718) |

9921W: made by Eastman Kodak Co.
IFG8L: made by Kanebo Gohsen K.K.
710B4: made by Kanebo Gohsen K.K.

(3) Formation and Extraction of Stretched Films

The above-obtained sheets were stretched at 120° C. to obtain stretched films FS1-FS6, which were then heat-fixed at 150° C. The heat-fixed films were subjected to 8 hours of extraction under a hot-water retorting condition of 120° C. The results regarding the extraction are inclusively shown in Table 6. An extraction rate was calculated based on a weight change of each film before and after extraction. In order to confirm the accuracy of the thus-determined extraction rate, an extraction rate was also calculated based on the results of complete hydrolysis of PGA resin obtained by subjecting a stretched film and a film after the extraction of the stretched film respectively to 5 hours of immersion in 5% NaOH aqueous solution at 80° C. In this instance, the extraction rate was calculated based on a ratio of the amount (F g) of glycolic acid detected from a film after the extraction to the amount (E g) of glycolic acid detected from the film before the extraction. Thus, the extraction rate (%) was calculated as 100×(E-F)/F.

TABLE 6

| | | | | Extraction rate (%) | |
|---|---|---|---|---|---|
| | Stretched film | Stretched | Film strength of | Calculated from | Calculated from |
| Sheet name | name | ratio | extracted film | weight change | hydrolysis in alkali |
| S1 | FS1 | 7 | A | 91.5 | 92.2 |
| S2 | FS2 | 7 | B | 97.7 | 98.1 |
| S3 | FS3 | 7 | B | 100 | 99.7 |
| S4 | FS4 | 7 | A | 95.5 | 100 |
| S5 | FS5 | 6 | C | 99.2 | 98.9 |
| S6 | FS6 | 8 | A | 90.8 | 92.7 |

Film strength of extracted film
A: Sound film,
B: Slightly brittle
C: Considerably brittle

(4) SEM Observation

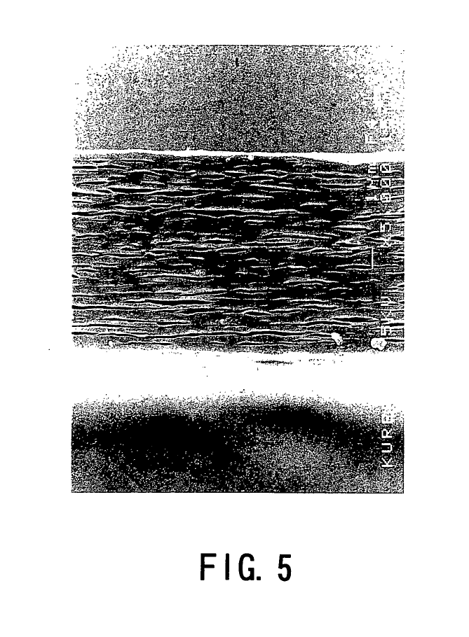

FIGS. 5-10 show SEM photographs of sections of the above-obtained extracted films FS1-FS6. The anisotropy and void percentage of major voids are inclusively shown in Table 7. Further, the results of the sectional observation are inclusively shown in Table 8. Incidentally, “viscosity” shown in Table 8 refers to a melt viscosity measured at 270° C. and a shear rate of 121/s.

TABLE 7
Anisotropy and void percentage of major voids

| Stretched | Thickness of | Anisotropy of | Void percentage |
|---|---|---|---|
| film name | extracted film | major voids | (%) |
| FS1 | 8.5 | ≧5 | 16 |
| FS2 | 8.0 | ≧5 | 21 |
| FS3 | 10.5 | ≧5 | 10 |
| FS4 | 8.5 | ≧5 | 26 |
| FS5 | 7.5 | ≧5 | 35 |
| FS6 | 12.5 | ≧5 | 3 |

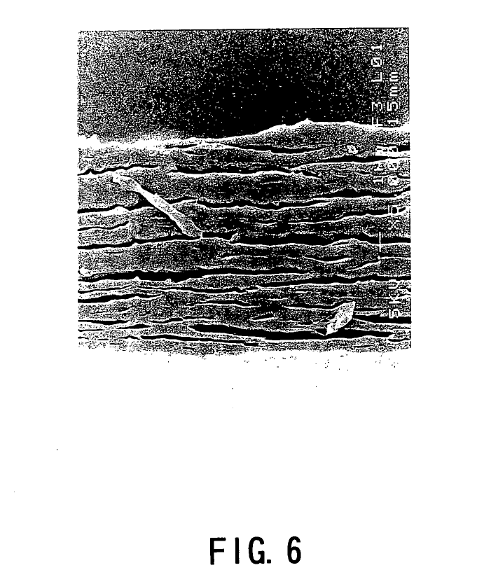

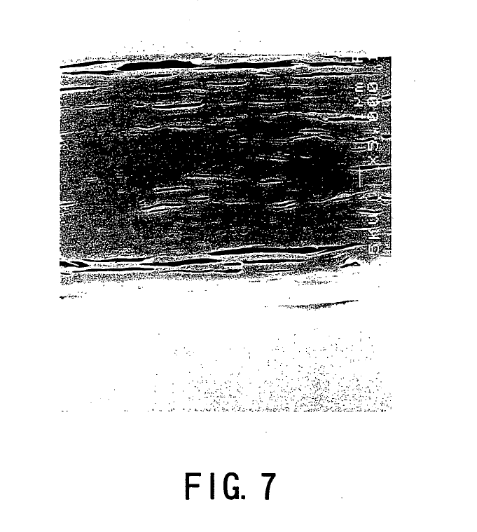

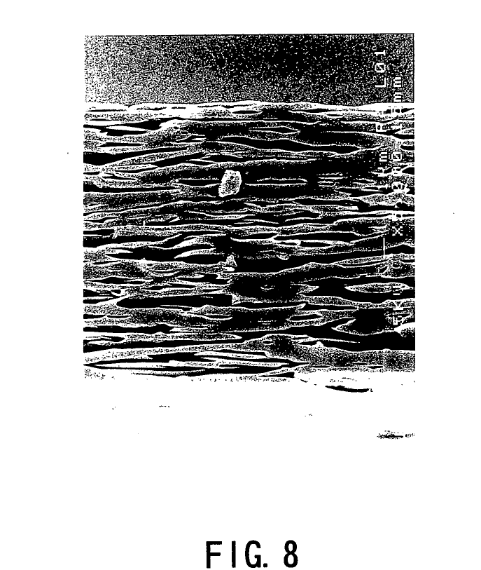

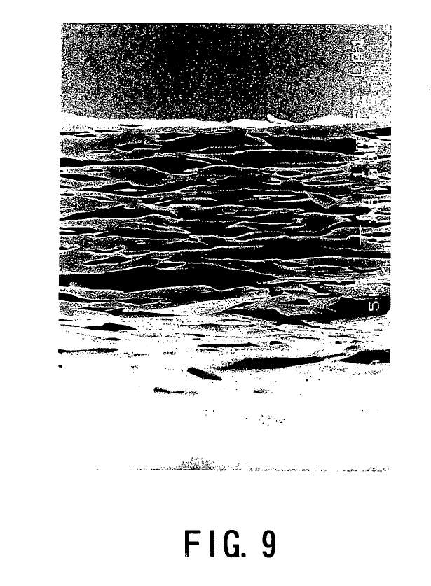

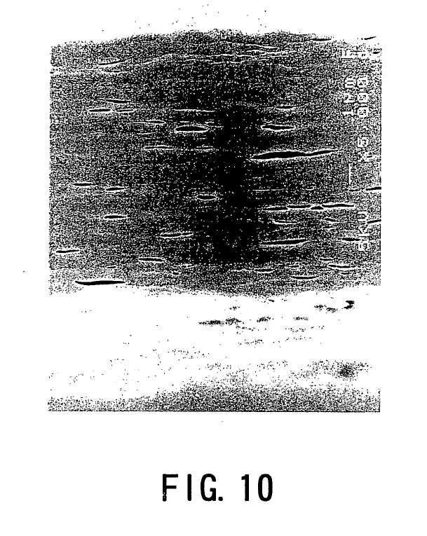

TABLE 8
Information obtained from sectional observation of extracted films

| | | Corresponding |
|---|---|---|
| Point of change | Observation of voids | stretched film |
| Similar viscosities | Taken as standard (FIG. 5) | FS1 |
| of PET and PGA | | |
| Increased degree | Larger thickness of voids | FS2 |
| of kneading | (FIG. 6) | |
| Lower viscosity of PET | Smaller thickness of voids, | FS3 |
| | Localization of voids at sheet | |
| | surfaces (FIG. 7) | |
| Higher viscosity of PET | Larger thickness of voids | FS4 |
| | (FIG. 8) | |
| Higher PET viscosity, | Larger thickness of voids | FS5 |
| larger GPA content | (FIG. 9) | |
| Higher PET viscosity, | Smaller thickness of voids | FS6 |
| lower PGA content | (FIG. 10) | |

(5) Extraction Speed

In order to obtain information regarding the extraction speed, stretched sheet FS4 was subjected to extraction under different retorting extraction conditions. The results are inclusively shown in Table 9.

TABLE 9
Extraction speed

| | | Extraction rate (%) | | |
|---|---|---|---|---|
| | | Extraction medium | | |
| | | | 15% glycolic acid | |
| Extraction time | | water | aqueous solution | steam 120° C. |
| 1 | hr | 4.0 | 14.5 | |
| 3 | hrs | 40.7 | 54.6 | 28.5 |
| 6 | hrs | 97.7 | 100 | 76.4 |
| 8 | hrs | 100 | | |
| 12 | hrs | | | 100 |

(6) Effect of Stretching Ratio

Sheet S4 was stretched at various stretching ratios, and a non-stretched film FS4-1 and the resultant stretched films FS4-10 and FS4-20 were subjected to the extraction test. As a result, the non-stretched film only resulted in gushed voids. Ag a higher stretching ratio, a film having

TABLE 10
Stretch ratio and void percentage

| | | Anisotropy of | Void |
|---|---|---|---|
| | Stretch | major voids | percentage |
| Stretch ratio | film name | (L/D) | (%) |
| Non-stretched | FS4-1 | ≦2 | 0.1 |
| 10-times | FS4-10 | ≧5 | 30 |
| 20-times | FS4-20 | ≧5 | 38 |

II. Production of Fine Fiber

### Example 3

PET resin (“9921W”, made by Eastman Kodak Co.) and PGA resin (“PGA-2”, made by Kureha Kagaku K. K.) used in the above-described section I. (Example 2) were blended at weight ratios of 75/25, 50/50 (the same as in B1 in Example 2 above) and 25/75, respectively, and melt-kneaded to obtain three species of pellets, which were then respectively extruded through a 35 mm-dia. extruder with cylinder temperatures of 230-260° C. and through 12 nozzles each of 0.8 mm in diameter, followed by cooling in air and spinning at a pulling speed of 30 m/min. and a draft ratio of 28 times to obtain three species of stretched yarn each having a diameter of 150 μm.

The above-obtained three species of stretched yarn were respectively subjected to 12 hours of extraction under a hot-water retorting condition of 120° C., whereby a bundle (in a whole diameter of ca. 50-100 μm) of ultrafine fiber having a diameter of ca. 0.2-0.5 μm was obtained in each case. The thus-obtained three species of ultrafine fiber provided photographs (×5000) of longitudinal sections (FIGS. 11-13) and photographs (×5000) of diametrical sections (FIGS. 14-16).

Each fiber bundle was in such a state that it could be easily disintegrated into unit fibers by finger action. III. Production of porous hollow fiber.

### Example 4

100 wt. parts of PVDF (“KF#1100”, made by Kureha Kagaku Kogyo K. K.) and 120 wt. parts of PGA (weight average molecular weight (Mw)=250,000) were blended by a Henschel mixer and pelletized through a 30 mm-dia. twin-screw extruder (“LT-20”, made by Toyo Seiki Seisakusho) at 270° C. Then, the pellets were extruded through the same extruder but equipped with a hollow fiber production apparatus to form hollow fiber having an outer diameter of 1.6 mm and an inner diameter of 0.7 mm.

The hollow fiber was then boiled for 6 hours in an ethanol/water (30/70) mixture liquid at 120° C., followed by drying to obtain a hollow fiber of PVDF having a porosity of 57% and an average pore diameter of 0.67 μm.

[C. Post treatment of Extraction Waste Liquid]

### Example 5

An extraction operation identical to the above-mentioned extraction speed test (5) in B.II. Production of porous fiber, Example 2, described above, was repeated 50 times with respect to the stretched sheet FS4 with steam as the extraction medium, whereby a glycolic acid solution at a concentration of 43% was obtained.

Then, the glycolic acid solution was subjected to the process of PCT published specification WO 02/14303 to obtain PGA again, through oligomer and glycolide.

More specifically, the above obtained glycolic acid solution at a concentration of 43% was charged in an autoclave and stirred at normal pressure under heating while removing the remaining water, followed further by heating from 170° C. to 200° C. in 2 hours to effect a condensation reaction while distilling off the produced water. Then, the pressure in the autoclave was reduced to 5.0 kPa and heated at 200° C. for 2 hours to distil off low-boiling fractions, such as non-reacted starting material, thereby obtaining glycolic acid oligomer.

Then, 40 g of the above-prepared glycolic acid oligomer was charged in a 300 ml-flask connected with a receiver cooled with cold water, and 200 g of separately prepared tetraethylene glycol dibutyl ether (TEG-DB) as a solvent polyalkylene glycol (B) was added thereto. The mixture of the glycolic acid oligomer and the solvent was heated at 280° C., whereby it was confirmed by observation with eyes that the glycolic acid oligomer was uniformly dissolved in the solvent with substantially no phase separation. On continued heating, the pressure in the flask was reduced to 10 kPa to start co-distillation of glycolide due to de-polymerization and the solvent. The de-polymerization was completed in ca. 4 hours.

After completion of the co-distillation, glycolide precipitated from the distillate liquid was separated and re-crystallized from ethyl acetate to obtain glycolide at a purity of 99.99%. The glycolide was subjected to ring-opening polymerization to obtain recovered polyglycolic acid (PGA-R).

### Example 6

The copolymer PET (“PET-DA5”) and the recovered polyglycolic acid (“PGA-R”) were blended in proportions shown in Table 11 to obtain PET/PGA composition samples R1-R5.

The operation of sheet formation, extraction and SEM observation were performed in the same manner as in Example 1 except for using the thus-obtained compositions R1-R5. The results including the void percentages, etc., are inclusively shown in Tables 12 and 13.

TABLE 11

PET/PGA composition (wt. %)

| Sample name | PET (PET DA5) | PGA (PGA-1) |
|---|---|---|
| R1 | 90 | 10 |
| R2 | 80 | 20 |
| R3 | 70 | 30 |
| R4 | 60 | 40 |
| R5 | 55 | 45 |

TABLE 12
Stretching ratio and extraction rate

| | Stretched | Stretched | Extraction |
|---|---|---|---|
| Sample name | film name | ratio | rate (%) |
| R1 | FR1 | 15 | 98 |
| R2 | FR2 | 17 | 100 |
| R3 | FR3 | 18 | 99 |
| R4 | FR4 | 20 | 98 |
| R5 | FR5 | 17 | 97 |

TABLE 13
Anisotropy and void percentages of major
voids of films after extraction

| | | Thickness of | Anistoropy | |
|---|---|---|---|---|
| Sample | Stretched | extracted | of major | Void percentage |
| name | film name | film (μm) | voids (L/D) | (%) |
| R1 | FR1 | 15 | ≧5 | 6 |
| R2 | FR2 | 14 | ≧5 | 8 |
| R3 | FR3 | 14 | ≧5 | 10 |
| R4 | FR4 | 17 | ≧5 | 12 |
| R5 | FR5 | 15 | ≧5 | 14 |

### INDUSTRIAL APPLICABILITY

As described above, according to the present invention, there is provided a simple process of forming a shaped composite of a polyglycolic acid resin as a forming aid and a substantially water-insoluble thermoplastic resin, and causing the shaped composite to contact an aqueous medium, thereby selectively removing the polyglycolic acid resin through solvolysis and extraction to leave various forms of shaped products, such as porous films or fiber, ultrafine fiber and ultrathin films, of the remaining thermoplastic resin. Further, glycolic acid contained in the extraction waste liquid can be effectively recovered as polyglycolic acid as the starting material through glycolide.

1. A process for producing a thermoplastic resin shaped product, comprising: causing a shaped composite of a polyglycolic acid resin and a substantially water-insoluble thermoplastic resin to contact an aqueous medium, and selectively removing the polyglycolic acid resin by solvolysis and extraction thereof from the shaped composite, thereby recovering a shaped product of the remaining thermoplastic resin.

2. A process according to claim 1, wherein the aqueous medium comprises water, a lower alcohol miscible with water or a mixture of these.

3. A process according to claim 1, wherein the aqueous medium is at an elevated temperature.

4. A process according to claim 1, wherein the aqueous medium contains an acid or an alkali.

5. A process according to claim 4, wherein the aqueous medium comprises an aqueous solution of glycolic acid.

6. A process according to claim 5, wherein the glycolic acid is a hydrolyzed product of the polyglycolic acid resin.

7. A process according to claim 1, wherein the shaped composite is a shaped product of a hot-kneaded mixture of the polyglycolic acid resin and the water-insoluble thermoplastic resin.

8. A process according to claim 1, wherein the shaped composite is a regularly arranged shaped product of the polyglycolic acid resin and the water-insoluble thermoplastic resin.

9. A process according to claim 1, wherein the shaped composite is a stretched shaped product.

10. A process according to claim 1, wherein the water-insoluble thermoplastic resin is an aromatic polyester resin.

11. A thermoplastic resin shaped product produced through a process according to claim 1.

12. A thermoplastic resin shaped product according to claim 11, in the form of a porous film or sheet.

13. A thermoplastic resin shaped product according to claim 12, having heat-shrinkability.

14. A thermoplastic resin shaped product according to claim 12, comprising an aromatic polyester resin.

15. A thermoplastic resin shaped product according to claim 11, in the form of ultrafine fiber.

16. A thermoplastic resin shaped product according to claim 15, comprising an aromatic polyester resin.

17. A thermoplastic resin shaped product according to claim 11, in the form of a porous hollow fiber.

18. A thermoplastic resin shaped product according to claim 13, comprising a polyvinylidene fluoride resin.
